(19) United States
(12) Patent Application Publication
(10) Pub. No.: US 2023/0388397 A1
(43) Pub. Date: Nov. 30, 2023

(54) Resolving Overlapping IP Addresses in Multiple Locations

(71) Applicant: SOFTIRON LIMITED, CHILWORTH (GB)

(72) Inventor: Kenny Van Alstyne, Mechanicsville, VA (US)

(73) Assignee: SOFTIRON LIMITED, CHILWORTH (GB)

(21) Appl. No.: 18/322,917

(22) Filed: May 24, 2023

Related U.S. Application Data
(60) Provisional application No. 63/345,479, filed on May 25, 2022.

(51) Int. Cl. H04L 69/167; H04L 69/16

(52) U.S. Cl. CPC H04L 69/167; H04L 69/161

(57) ABSTRACT

A server includes a processor and a medium with instructions that cause the processor to determine machines in a network. Each of the machines are to have a same IPv4 address. The processor is further to derive an IPv6 packet for communication to a first machine of the machines to have the same IPv4 address. The IPv6 packet is to include an address. The address is to include the IPv4 address and a subnetwork identifier. The subnetwork identifier is to identify a portion of the network in which the first machine is an only machine with the IPv4 address.

### PRIORITY

This application claims priority to U.S. Provisional Patent Application No. 63/345,479 filed May 25, 2022, the contents of which are hereby incorporated in their entirety.

### FIELD OF THE INVENTION

The present disclosure relates to internet protocol (IP) addressing of electronic devices and, more particularly, to resolving overlapping IP addresses in multiple locations.

### BACKGROUND

IP version 4 (IPv4) has a concept of routable and non-routable addresses. Routable addresses can use the wide area network to communicate. Non-routable addresses may be solely limited to use within the local area. There are a limited set of non-routable addresses, such as 10.0.0.0/8, 172.16.0.0/12 and 192.168.0.0/16 (using CIDR notation). Due to the large number of local area networks and the limited number of non-routable addresses, it is not unusual to find that multiple local area networks may have common local non-routable subnet addresses in common. These may be referred to as overlapping IP addresses.

The need to manage networks can be accomplished either internally, through a corporate IT department, or externally through a managed services provider. Usually there is a need for a centralized management plane to access all managed clients, with a subset of services needing to be reachable from the endpoint. In the case of a managed service, overlapping IPv4 addresses can be encountered when adding a new customer or an existing customer adding a new location. In the case of a network managed by a corporate IT department, this can often be encountered when employees work from home (WFH). Many WFH networks use the default router configurations which results in many overlapping IPv4 addresses. WFH has increased recently, and this has created new challenges for IT departments to manage WFH employees (or customers).

There are existing solutions that resolve these overlaps, each with their own shortcomings.

Network Address Translation (NAT) may be used. In this technique, the local non-routable addresses can be converted to new non-routable addresses. For example, using NAT44:
SiteA 192.168.0.1→10.10.10.1
SiteB 192.688.0.1→10.10.20.1

There are limitations to this approach. First, the management entity (managed service provider or corporate IT) will need to allocate, reference and manage the translated IPv4 addresses. Second, particularly when connecting WFH endpoints, there may be a limitation of the translated address due to a collision of the local network address e.g. if SiteC uses 10.10.0.0/16 for a local address.

464XLAT may be used. This approach involves embedding the IPv4 local address into an IPv6 packet to connect on the managed network. A customer side translator (CLAT) and provider side translator (PLAT) are used to embed the IPv4 address from the client side into an IPv6 packet sent to the provider. However, a translation-aware device must be placed inline, usually at the router. Client software must support IPv6. The connection information state may include source and destination IP ports, protocols such as transmission control protocol (TCP), user datagram protocol (UDP), or Internet control message protocol (ICMP), and a connection status, such as “ESTABLISHED” The connection information state must be maintained for both examples/directions, which could be a bottleneck in very busy networks.

Embodiments of the present disclosure address one or more of these issues.

### BRIEF DECRIPTION OF THE DRAWINGS

FIG. 1 is an illustration of an example of an IPv6 address structure, according to embodiments of the present disclosure.

FIG. 2 is an illustration of an exemplary system architecture for management plane traffic to multiple end clients, according to embodiments of the present disclosure.

FIG. 3 is an illustration of access by IPv4 endpoints of common services, according to embodiments of the present disclosure.

### DETAILED DESCRIPTION

Embodiments of the present disclosure may include a mesh layer 2 network fabric, which can be connected in one of many ways. Embodiments of the present disclosure may be implemented by Layer 2 virtual private network (VPN) tunnels between routers, Layer 2 VPN tunnels originated in an automated way by an inline smart switch, or by physical cabling (such as an ethernet network).

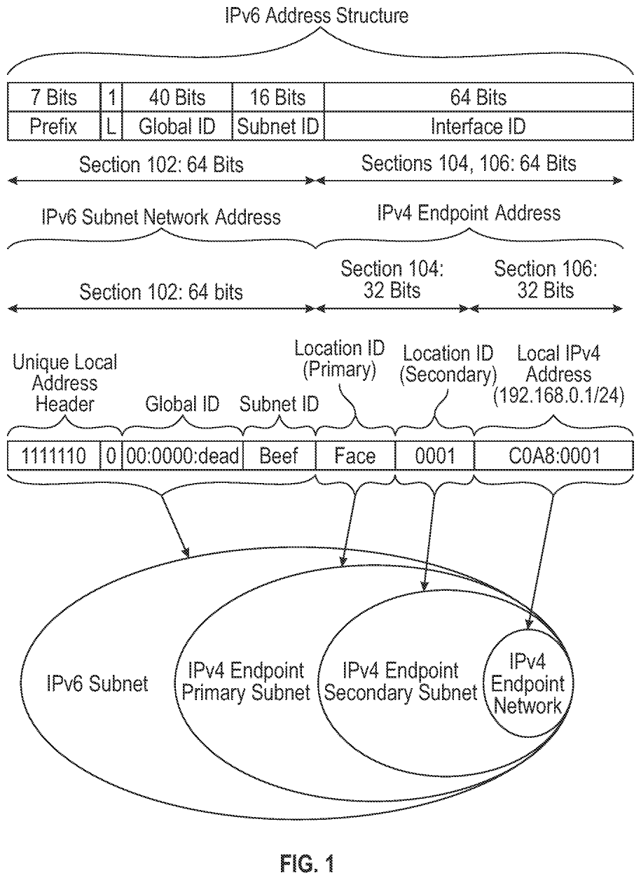

FIG. 1 is an illustration of an example of an IPv6 address structure, according to embodiments of the present disclosure.

According to embodiments of the present disclosure, over a layer 2 network fabric, the IPv6 protocol may be utilized to provide the ability to manage multiple overlapping IPv4 network ranges. As shown in FIG. 1, an IPv6 address can include multiple parts.

The structure may include an initial eight bits. The initial eight bits may be used to set or specify the type of packet that is being used to transfer data. In one embodiment, the first eight bits may be a Unique Local Address (ULA) header or packet. These packets may be private, non-routable within the larger context of a wide area network, and may only be used in local area networks (LANs) or VPNs.

The structure may include an IPv6 global ID and an IPv6 Subnet ID, which may be used for packet addressing within LANs or VPNs.

The structure may include an IPv6 interface ID, which may include an additional 64-bit of address space used by embodiments of the present disclosure. Given that IPv4 addresses are only 32-bits, this allows the creation of many unique 32-bit address ranges inside the overall 128-bit address space of the shown IPv6 address structure. This address space can be further subdivided to provide additional differentiation between overlapping addresses of embodiments of the present disclosure.

The 128 bits of the IPv6 address structure can be broken into three sections as shown in FIG. 1. A first section 102 may be 64 bits long and may contain a ULA header or prefix, L bit, global ID and subnet ID. The IPv6 global ID field may include the part of the overall address that makes the ULA prefix globally unique. A given global ID can be assigned to a specific organization, for example. Within such an organization, IPv6 subnet IDs can be used to reference different networks within that organization. In this manner, a standard IPv6 subnet can be built where the remaining 64 bits (outside of section 102) of the IPv6 address space can be used for further segmented addressing.

The interface ID may include second and third sections 104, 106, which may be a total of 64 bits long in combination.

The second section 104 may be further broken down into two subsections. The second section 104 may include a location identifier, given as location ID (primary). The second section 104 may include another location identifier, given as location ID (secondary). The location ID (primary) may be used as the first level of aggregation, e.g., a customer. The location ID (secondary) may be a second level of aggregation, e.g., a specific site among many possible sites for the customer.

The third section 106 may contain the local IPv4 address. This IPv4 address may be 32 bits long. In this manner, multiple devices may share the same local IPv4 address within a larger network defined by location IDs (primary and secondary), though the same address cannot be shared by multiple devices within a same smallest granular sub-network. Such devices with the same local IPv4 addresses may be said to have overlapping IPv4 addresses. The source location of each overlapping IPv4 address can be uniquely identified from the information contained in the interface ID of the IPv6 addresses.

As shown in FIG. 1, the IPv6 network is first segregated into a IPv6 subnet. This may include all endpoints in the network. The IPv6 network may be defined according to the IPv6 Subnet Network Address of section 102. All endpoints in the network may include the same values for section 102 of their respective addresses. The endpoints in the network may include different values for sections 104, 106 of their respective addresses. Multiple endpoints within the IPv6 subnet may have the same IPv4 address in section 106.

A second segregation subdivides the IPv6 subnet and creates the IPv4 Endpoint primary subnet. This may include all endpoints within a same location ID (primary) of the network and may have a common location ID (primary value). All endpoints in the IPv4 endpoint primary subnet may include the same values for the location ID (primary) of their respective addresses. Entities with overlapping IP addresses may reside therein.

A third level of segregation in turn creates the IPv4 Endpoint secondary subnet which contains the IPv4 network where the entities with overlapping IP addresses reside. This may include all endpoints within a same location ID (secondary) of the network. All endpoints in the IPv4 Endpoint secondary subnet may include the same values for the location ID (secondary) of their respective addresses.

Within the fourth level of segregation, all endpoints may have different values for the local IPv4 address for section 106.

Consider the two sites discussed above, SiteA and SiteB. Each site could have a Location ID face:1 and fade:1, respectively (note: face and fade are hexadecimal values). SiteA and SiteB thus might be two locations within a same IPv6 subnet. Furthermore, a same IP address such as 192.168.0.1 could be assigned to devices in each of SiteA and SiteB. This might result in the creation of the following ULA IPv6 addresses:
SiteA 192.168.0.1→fc00:0:dead:beef:face:1:C0A8:0001
SiteB 192.168.0.1→fc00:0:dead:beef:fade:1:C0A8:0001

In this addresss, fc may be the ULA header. The value 00:0000:dead may be the global ID portion of the ULA header. The hexadecimal value “beef” may be the subnet ID of the ULA packet header (i.e., 00:0000:dead:beef::/64 defines the IPv6 subnet, first level identifier)

The value face:1 may be the location ID for SiteA. “face” may be the second identifier denoting the primary portion of location ID, with 00:0000:dead:beef:face:/80 defining the IPv4 Endpoint primary subnet. “1” may be the third identifier denoting secondary portion of location ID, with 00:0000:dead:beef:face:0001::/96 defining the IPv4 Endpoint secondary subnet).

The value fade:1 may be the location ID for SiteB. “face” may be is the second identifier denoting the primary portion of location ID, with 00:0000:dead:beef:face::/80 defining the IPv4 Endpoint primary subnet, and “1” may be the third identifier denoting secondary portion of location ID, with 00:0000:dead:beef:face:0001::/96 defining the IPv4 Endpoint secondary subnet. “c0a8:0001” is the hexedecimal equivalent of 192.168.0.1.

An advantage of this approach over the NAT44 approach is allowing for subnetting of the endpoints. In the case of NAT44, the address mapping must be carefully designed to allow subnetting at the host side. In the above example, subnetting at the host side is not required as the location ID portion of the IPv6 address may be used instead to separate traffic between SiteA and SiteB.

In the case where SiteA has several WFH endpoints, each WFH endpoint can be given its own subordinate, location ID (secondary), designation. For example, three endpoints in SiteA could be defined by:
SiteA WFH endpoint 1 192.168.0.1→fc00:0:dead:beef:face:1:C0A8:0001
SiteA WFH endpoint 2 192.168.0.1→fc00:0:dead:beef:face:2:C0A8:0001
SiteA WFH endpoint 3 192.168.0.1→fc00:0:dead:beef:face:3:C0A8:0001

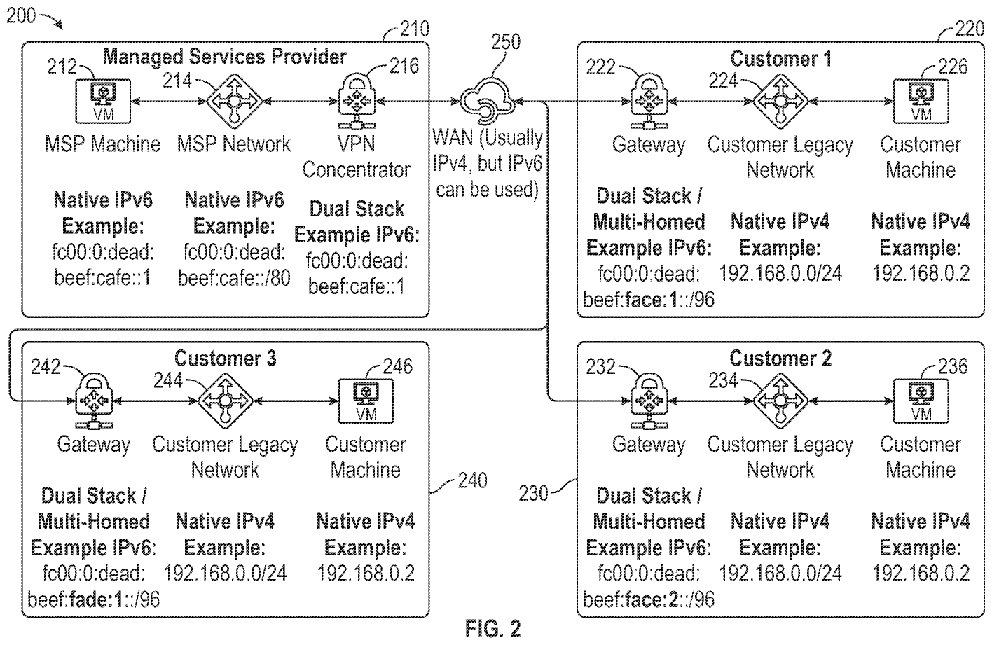

FIG. 2 shows a network topology with overlapping IP addresses in use, according to embodiments of the present disclosure. In this example, multiple devices may use the same address (192.168.0.2) without the methodology of manually managed NATs. Additionally, from the native IPv6 network, a well-known address for customer IPv4 addresses can be maintained. The methodology may be as follows.

Customer 1 220 may have customer machine 226 with IPv4 address 192.168.0.2. Similarly, customer 2 230 and customer 3 240 may also have customer machines 236 and 246 which also have IPv4 address 192.168.0.2. In the respective three cases, the respective customer machine is connected to customer legacy networks 224, 234 and 244, which may each in turn have an IPv4 address of 192.168.0.0/24. These addresses are known as overlapping IPv4 addresses as they are all identical.

In the case of customer 1 220, gateway 222 may be assigned IPv6 address range fc00:0:dead:beef:face:1::/96 using Classless Inter-Domain Routing (CIDR). Gateway 222 may be a dual stack multi-homed gateway 222. The IPv4 address of customer machine 226, along with the location ID (primary) “face” and location ID (secondary) “0001”, in the assigned IPv6 address “fc00:0:dead:beef::/64”, may yield the IPv6 address “fc00:0:dead:beef:face:1:c0a8:0002/128”. A detailed view of the construction of this IPv6 address, and the associated subnetting, is shown in FIG. 1.

For customer 2 230, customer machine 236 with IPv4 address 192.168.0.2 produces “fc00:0:dead:beef:face:2:c0a8:0002/128” for its assigned IPv6 address. Customer machine 236 includes the location ID of “face:2” as opposed to “face:1” of customer machine 226 because customer machine 236 is managed behind gateway 232 with the location identifier “face:2”. The secondary location IDs are different.

For customer 3 240, customer machine 246 with IPv4 address 192.168.0.2 produces “fc00:0:dead:beef:fade:1:c0a8:0002/128” for its assigned IPv6 address. Customer machine 246 includes the location ID of “fade:1” as opposed to “face:2” or “face:1” of customer machines 226, 236 because customer machine 246 is managed behind gateway 242 with the location identifier “fade:1”. The primary location IDs are different.

In this previous example, the location ID (primary) is thus used to uniquely identify the location of the overlapping IPv4 address as follows:

| | Location ID | Location ID |
|---|---|---|
| Location | (primary) | (secondary) |
| Customer 1 Site 1 | face = 1111:1010:1100:1110 | 0001 |
| Customer 1 Site 2 | face = 1111:1010:1100:1110 | 0002 |
| Customer 2 Site 1 | fade = 1111:1010:1101:1110 | 0001 |

Not only have individual IPv6 addresses been derived, but customers 1 and 2 (220 and 230) can be associated using fc00:0:dead:beefface::180. Customer 3 (240) is associated with fc00:0:dead:beef:fade::/80. These associations can be used for subnetting in, for example, a managed services provider (MSP) network. For example, fc00:0:dead:beefface::/80 would identify all packets for customer machine (226, 236) instances used by customer 1 in both Site 1 and Site 2. The designation of “/80” may indicate that the last 48 bits of the address are a variable or wildcard mask,

Each customer (220, 230 and 240) can be connected via a VPN connection through a wide area network 250 and the respective gateway (222, 232 and 242) of customer 220, 230, 240. These VPN connections may terminate, for example, in a VPN Concentrator 216 of Managed Services Provider 210. VPN Concentrator 216 may connect to MSP Network 214, which may have an IPv6 network having IPv6 address fc00:0:dead:beef: cafe::/80. MSP 210 may include an MSP machine 212, which may also be connected to MSP network 214, and may have an IPv6 address of fc00:0:dead:beef:cafe::1. This may allow MSP machine 212 to connect directly, in a stateful manner, with any or all customer machines (226, 236 and 246).

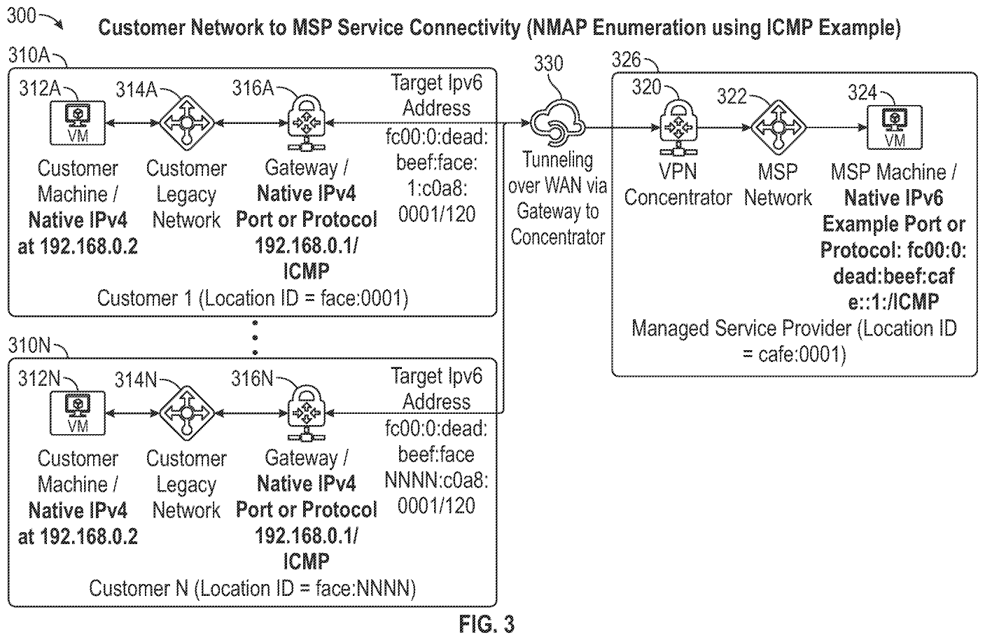

FIG. 3 shows an example of a managed service provider using a unified layer 2 fabric to enumerate endpoints, in accordance with embodiments of the present disclosure.

It may be useful to enumerate the endpoint devices that are connected to a network 300. This can be done using ICMP packets such as NMAP and ping packets. However, the overlapping IPv4 address 192.168.0.2 of multiple machines such as customer machines 312A-312N in different customer networks 310 would make enumeration difficult to accomplish. For example, customer network 310A may include a machine 312A with the native IPv4 address 192.168.0.2, and customer network 310N may include a machine 312N with the same native IPv4 address, 192.168.0.2.

An MSP 326 may be configured to enumerate these multiple endpoints in network 300. MSP 326 may include a native MSP machine 324. MSP machine 324 may include IPv6 address fc00:0:dead:beef:cafe::1:, and may be used to host an application to enumerate endpoints. The endpoint enumeration application can then selectively use IPv6 addressing to access the IPv4 endpoints.

Initially, MSP machine 324 can scan ports and protocols as given by application of a command (such as an NMAP command or ping) for ports fc00::dead:beef:face:1:c0a0:0/120. The application of the NMAP command for ports fc00::dead:beef:face:1:c0a0:0/120 may scan legacy customer network 310A. The designation of “/120” may indicate that the last 8 bits of the address are a variable or wildcard mask. The last 8 bits of the address may correspond to the last 8 bits of an IPv4 address, which may cover all non-routable or internal addresses. Similarly, the application of the NMAP command for ports fc00::dead:beef:face:NNNN:c0a0:0/120 may scan legacy customer network 310N. Separate NMAP commands may be sent to each gateway 316 of network 300. Gateways 316 may perform addressing packaging and depackaging for the NMAP command and responses thereto. Gateways 316 may perform NMAP enumeration of IPv4 endpoints (such as endpoints 312) by issuing ping commands to IPv4 endpoints in IPv4 endpoints, and packaging the results into IPv6 format for return to MSP 326.

The NMAP command may scan the IPv4 endpoint 312A in customer network 1 310A (which has location ID face:0001), as well as all other IPv4 endpoints (not shown) in network 314A behind gateway 316A because the parameters of ports fc00::dead:beef:face:1:c0a0:0/120 may include scanning address 192.168.0.0/24 in customer 1 legacy network 314A. Customer machine 312A may be included in the scan since the IPv6 address fc00:0:dead:beef:face:0001:c0a0:0002: (included in the permutations of pings issued to network 314A by gateway 316A) may access its IPv4 address, 192.168.0.2. Further, address fc00:0:dead:beef:face:0001:c0a0:0002 may be recoded for customer machine 312A. Similarly, gateway 316N may use the parameter fc00::dead:beef:face:NNNN:c0a0:0/120 to scan customer legacy network 314N of customer 2 312N. NNNN is the part of the location ID that identifies customer N. In this instance, customer machine 312N with IPv4 address 192.168.0.2 may be recorded as fc00::dead:beef:face:NNNN:c0a0:0002. So, even though customer machine 312A, 312N have the same IPv4 address, the scan may result in two different IPv6 addresses: fc00::dead:beef:face:0001:c0a0:0002, and fc00::dead:beef:face:NNNN:c0a0:0002, respectively. In addition, by isolating the location IDs, face:0001 and face:NNNN, the specific customer location can be easily derived. This allows a single location in managed service provider 326, i.e. fc00:0:dead:beef: café:1, to access multiple customer machines 312A, 312N with the same overlapping IPv4 address 192.168.0.2.

Embodiments of the present disclosure may include a server. The server may include a processor and a non-transitory machine-readable medium including instructions. The instructions, when loaded and executed by the processor, may cause the processor to determine a plurality of machines in a network, each of the plurality of machines to have a same IPv4 address. The processor may be caused to, for communication to a first machine of the plurality of machines to have the same IPv4 address, derive an IPv6 packet, the IPv6 packet to include an address, the address to include the IPv4 address and a subnetwork identifier, the subnetwork identifier to identify a portion of the network in which the first machine is an only machine with the IPv4 address.

In combination with any of the above embodiments, the address may further include a network identifier common to all machines of the network.

In combination with any of the above embodiments, the network identifier common to all machines of the network may be 56 bits long.

In combination with any of the above embodiments, the subnetwork identifier may include a first level identifier, the first level identifier to identify a first level subnetwork of the network, wherein a plurality of machines have the same IPv4 address within the first level subnetwork.

In combination with any of the above embodiments, the first level identifier may be 16 bits long.

In combination with any of the above embodiments, the subnetwork identifier may includes a second level identifier, the second level identifier to identify a second level subnetwork of the network.

In combination with any of the above embodiments, a plurality of machines may have the same IPv4 address within the second level subnetwork.

In combination with any of the above embodiments, a single machine may have the IPv4 address within the second level subnetwork.

In combination with any of the above embodiments, the subnetwork identifier may be 32 bits long.

In combination with any of the above embodiments, the second level identifier may be 16 bits long.

In combination with any of the above embodiments, the subnetwork identifier may include a first level identifier and a second level identifier, the first level identifier to identify a first level subnetwork of the network, the second level identifier to identify a second level subnetwork of the network, the second level subnetwork within the first level subnetwork of the network.

In combination with any of the above embodiments, a plurality of machines may have the same IPv4 address within the second level subnetwork, and a single machine may have the IPv4 address within the first level subnetwork.

In combination with any of the above embodiments, the instructions may be further to cause the processor to establish a network connection between a plurality of machines with the same IPv4 address.

In combination with any of the above embodiments, the instructions may be further to cause the processor to establish the network connection between the plurality of machines with the same IPv4 address through derivation of unique IPv6 addresses that include the IPv4 address.

In combination with any of the above embodiments, the IPv4 address may be untranslated as it appears in respective IPv6 addresses or is in its original form.

In combination with any of the above embodiments, wherein the instructions may be further to cause the processor to issue a plurality of commands, each command to map a subnetwork of the network according to respective instances of the subnetwork identifier, each subnetwork capable of including a machine with the same IPv4 address, the command further to include a mask to include a subnet of machines wherein each machine has a unique IPv4 address.

In combination with any of the above embodiments, the instructions may be further to cause the processor to receive a command to map a subnetwork connected to the server, the server between the subnetwork and an origin of the command, the command to include a mask to include a subnet of machines wherein each machine has a unique IPv4 address, the subnetwork to include the subnet of machines. The instructions may be further to cause the processor to issue an identifying command to each machine on the subnetwork to obtain an IPv4 address of each machine on the subnetwork, build an IPv6 address for each machine on the subnetwork including the IPv4 address of each machine on the subnetwork, and provide the IPv6 addresses to the origin of the command.

Embodiments of the present disclosure may include methods performed by any of the above servers.

Although example embodiments have been described above, other variations and embodiments may be made from this disclosure without departing from the spirit and scope of these embodiments.

We claim:

1. A server, comprising:
a processor; and
a non-transitory machine-readable medium including instructions, the instructions, when loaded and executed by the processor, cause the processor to:
determine a plurality of machines in a network, each of the plurality of machines to have a same IPv4 address;
for communication to a first machine of the plurality of machines to have the same IPv4 address, derive an IPv6 packet, the IPv6 packet to include an address, the address to include:
the IPv4 address; and
a subnetwork identifier, the subnetwork identifier to identify a portion of the network in which the first machine is an only machine with the IPv4 address.

2. The server of claim 1, wherein the address further includes a network identifier common to all machines of the network.

3. The server of claim 1, wherein the network identifier common to all machines of the network is 56 bits long.

4. The server of claim 1, wherein the subnetwork identifier includes a first level identifier, the first level identifier to identify a first level subnetwork of the network, wherein a plurality of machines have the same IPv4 address within the first level subnetwork.

5. The server of claim 4, wherein the first level identifier is 16 bits long.

6. The server of claim 1, wherein the subnetwork identifier includes a second level identifier, the second level identifier to identify a second level subnetwork of the network.

7. The server of claim 6, wherein a plurality of machines have the same IPv4 address within the second level subnetwork.

8. The server of claim 6, wherein a single machine has the IPv4 address within the second level subnetwork.

9. The server of claim 6, wherein the subnetwork identifier is 32 bits long.

10. The server of claim 6, wherein the second level identifier is 16 bits long.

11. The server of claim 1, wherein the subnetwork identifier includes a first level identifier and a second level identifier, the first level identifier to identify a first level subnetwork of the network, the second level identifier to identify a second level subnetwork of the network, the second level subnetwork within the first level subnetwork of the network.

12. The server of claim 11, wherein:
a plurality of machines have the same IPv4 address within the second level subnetwork; and
a single machine has the IPv4 address within the first level subnetwork.

13. The server of claim 1, wherein the instructions are further to cause the processor to establish a network connection between a plurality of machines with the same IPv4 address.

14. The server of claim 13, wherein the instructions are further to cause the processor to establish the network connection between the plurality of machines with the same IPv4 address through derivation of unique IPv6 addresses that include the IPv4 address.

15. The server of claim 14, wherein the IPv4 address is untranslated as it appears in respective IPv6 addresses or is in its original form.

16. The server of claim 1, wherein the instructions are further to cause the processor to issue a plurality of commands, each command to map a subnetwork of the network according to respective instances of the subnetwork identifier, each subnetwork capable of including a machine with the same IPv4 address, the command further to include a mask to include a subnet of machines wherein each machine has a unique IPv4 address.

17. The server of claim 1, wherein the instructions are further to cause the processor to:
receive a command to map a subnetwork connected to the server, the server between the subnetwork and an origin of the command, the command to include a mask to include a subnet of machines wherein each machine has a unique IPv4 address, the subnetwork to include the subnet of machines;
issue an identifying command to each machine on the subnetwork to obtain an IPv4 address of each machine on the subnetwork;
build an IPv6 address for each machine on the subnetwork including the IPv4 address of each machine on the subnetwork; and
provide the IPv6 addresses to the origin of the command.

18. A method, comprising:
determining a plurality of machines in a network, each of the plurality of machines to have a same IPv4 address; and
for communication to a first machine of the plurality of machines to have the same IPv4 address, deriving an IPv6 packet, the IPv6 packet to include an address, the address to include:
the IPv4 address; and
a subnetwork identifier, the subnetwork identifier to identify a portion of the network in which the first machine is an only machine with the IPv4 address.
